(19) United States
(12) Patent Application Publication
(10) Pub. No.: US 2023/0214720 A1
(43) Pub. Date: Jul. 6, 2023

(54) TEMPORAL CO-GRAPH MACHINE LEARNING NETWORKS

(71) Applicant: Raytheon Company, Waltham, MA (US)

(72) Inventors: Philip A. Sallee, South Riding, VA (US); Christine R. Nezda, Richardson, TX (US); Joshua A. Binkley, Richardson, TX (US); Marta Tatu, Murphy, TX (US)

(21) Appl. No.: 18/093,163

(22) Filed: Jan. 4, 2023

Related U.S. Application Data
(60) Provisional application No. 63/296,331, filed on Jan. 4, 2022.

(51) Int. Cl. G06N 20/00; G06F 16/901

(52) U.S. Cl. CPC G06N 20/00; G06F 16/9024

(57) ABSTRACT

Discussed herein are devices, systems, and methods for more flexible temporal graph network (TGN) graph interaction. A method includes executing first and second temporal graph networks (TGNs) to generate embeddings of respective first and second dynamic graphs, storing, as respective edge features of a first node of the first graph and a second node of the second graph, a memory state vector of the first node and a memory state vector of the second node, and determining, based on the embeddings and the edge features, a likelihood of an edge between nodes of the first graph.

### CLAIM OF PRIORITY

This patent application claims the benefit of U.S. Provisional Patent Application No. 63/296,331, filed Jan. 4, 2022, entitled “TEMPORAL CO-GRAPH MACHINE LEARNING NETWORKS”, which is incorporated by reference herein in its entirety.

### TECHNICAL FIELD

Embodiments generally regard extending temporal graph networks (TGNs) to allow a first TGN graph to inform a node in a second TGN graph, a first node of a first TGN graph to inform a second node in the first TGN graph, or a first TGN graph to share memory state vector mappings with a second TGN graph.

### BACKGROUND

Twitter researchers, employees of Twitter, Inc. of San Francisco, Calif., have developed a machine learning (ML) algorithmic framework known as Temporal Graph Networks (TGN). TGN is limited in its ability to handle multiple types of nodes. The TGN framework can handle connections between bipartite graphs as it handles connections between two disjoint sets of nodes but cannot handle connections between nodes of the same set unless they are the only node type represented in the graph. For example, a graph input to TGN can model interactions between users and web pages, but not also direct interactions between users and/or between web pages, or with other types of entities in the same graph. Few approaches address fusing multiple types of features within temporal graphs. One approach (Ghosh, Pallabi, et al, 2020, “Stacked spatio-temporal graph convolutional networks for action segmentation.” Proceedings of the IEEE/CVF Winter Conference on Applications of Computer Vision, 2020.) fuses multiple spatia-temporal features by first converting different types of edge features to a common fixed length, and applying convolutional stacking models, but this approach is not suitable in general, where data does not occur at regularly sampled intervals.

### BRIEF DESCRIPTION OF THE DRAWINGS

FIG. 1 illustrates, by way of example, a flow diagram of a system for TGN operation.

FIG. 2 illustrates an exploded view diagram of an embodiment of a portion of the system of FIG. 1.

FIG. 3 illustrates, by way of example, a diagram of an embodiment of a multiple graph TGN system.

FIG. 4 illustrates, by way of example, a block diagram of an embodiment of a system that includes the system of FIG. 3 after another message is received and processed.

FIG. 5 illustrates, by way of example, a diagram of an embodiment of a method for multiple interacting dynamic graph operation.

FIG. 6 is a block diagram of an example of an environment including a system for neural network training.

FIG. 7 illustrates, by way of example, a block diagram of an embodiment of a machine in the example form of a computer system within which instructions, for causing the machine to perform any one or more of the methodologies discussed herein, may be executed.

### DETAILED DESCRIPTION

Machine learning (ML) using dynamic graphs can identify patterns and predict interactions between entities with a broad array of applications. Current applications of dynamic graphs include social networking modeling and predictions, such as predicting whether a user will interact with a tweet or re-tweet.

One example of a dynamic graph machine learning capability is a temporal graph network (TGN). The TGN models relationships that change over time. However, TGN only supports nodes of the same type or bipartite graphs that include connections only between disjoint sets of nodes. Embodiments allow for modeling of multiple node types with interactions within and across node types.

TGN graphs of embodiments identify patterns of activity in relationships that evolve and change over time, including normal and abnormal behavioral patterns of life (POL). Many real-world scenarios are well matched to temporal graphs, in which entities are modeled as nodes, and relationships between entities as edges. ML on temporal networks, in order to predict future nodes and edges, for instance, is an active area of current research with application to a broad array of problems. For example, embodiments are presented by explaining how ML, using temporal graphs, can be used on Automatic Identification System (AIS) ship tracking data to identify vessel POL. Other applications of multiple interacting dynamic graphs include entity co-location and co-travel, such as can include detecting co-movements and swarm behaviors, predicting movement along and between lines of communication, drone tracking, detection of violations or suspicious activity, cyber alerting—cluster and detect anomalies in patterns of network activity, among others.

Embodiments were built on Twitter's TGN framework and use multiple TGNs, each for a given graph, where each graph is bipartite or single node type. Edge features in one graph (containing one node type) can reference nodes within another graph (another node type). Vector representations of the nodes, the embedding memory state in the other graph, can be used as a feature of an edge. The ML parameters for each graph can be learned through a concurrent training process, with time-synchronization between batches of data samples for each graph. Embodiments are presented with an example in which there are separate entity and location graphs. However, the type of graph (node type) is variable and embodiments regard TGN graphs of any type and any number of TGN graphs. The two-graph situation extends to three graphs and so on. In the entity and location graph interaction, entity characteristics can inform the location patterns, and location characteristics can inform the entity patterns.

Combining multiple TGN graph networks and co-training multiple TGN graph networks has not been accomplished to the best of the knowledge of the inventors. Current dynamic graph research is focused on single graph analytics. Embodiments push the envelope on a technology that is already on the cutting edge of current technology, namely ML within predictive temporal graphs. Co-training mutually dependent graphs includes customization and extension of TGN constructs to achieve: 1) Time-synchronization: alternating training in batches to maintain synchronization can include adjustments to how timestamps are processed, and modular code for batch-wise training; 2) Multi-graph Identifiers: Node/edge identifications (IDs) can be maintained consistent between graphs and account for identifiers in one graph but not in the other; and 3) Dynamically generated edge features: TGN base code includes full edge features passed to the constructor. Naïve implementation that uses 172-dimensional edge features requires allocation of 100 plus gigabytes (GB) of random-access memory (RAM). Embodiments can generate these features on the fly. Since embeddings require edge features to compute, a deadlock situation can be avoided by using memory state vectors (MSVs) rather than embeddings for the edge features.

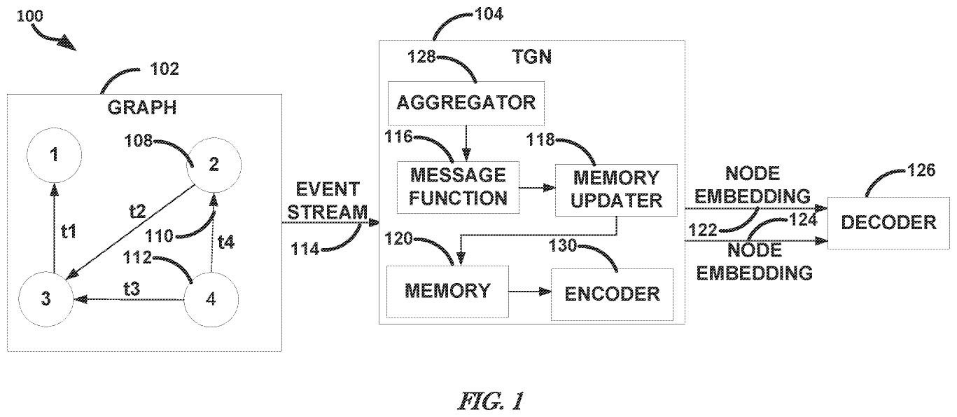

FIG. 1 illustrates, by way of example, a flow diagram of a system 100 for traditional TGN operation. The system 100 includes a dynamic graph 102, a TGN 104, and a decoder 106. The dynamic graph 102 comprises nodes 108, 112 (not all nodes are labeled) and edges 110 (not all edges are labeled). The nodes 108, 112 represent an entity and the edges 110 represent interaction between corresponding entities on ends of the edges 110. The dynamic graph 102 can be represented as an ordered list or an asynchronous stream 114 of temporal events, such as additions or deletions of nodes 108, 112 and edges 110. In the context of a social network, when an entity joins the platform, a new node can be created in the dynamic graph 102. When that entity follows another entity, an edge can be created that begins at the following entity and ends at the followed entity. When the entity changes their profile on the social network, the node for that entity can be updated.

Each event of the event stream 114 indicates nodes 108, 112, a type of edge 110, and a time. The event stream 114 is temporally sequenced such that the TGN 104 receives events with an earlier associated time before events with a later associated time. The event stream 114 is ingested by the TGN 104. The TGN 104 includes an encoder 130 neural network (NN) that produces a time-dependent embedding 122, 124 for each node 108, 112 of the graph 102 (regardless of whether the node 108, 112 was indicated in the event of the event stream 114). The embedding 122, 124 can then be fed into a decoder 126 that is designed and trained to perform a specific task. One example task is predicting future interactions between entities represented by the nodes 108, 112. For example, the decoder 126 can predict a likelihood that the entity associated with the node 112 will interact with the entity associated with the node 108 at or by a time, t4. The prediction is indicated as a dashed-line edge 110. The embeddings 122, 124 can be concatenated and fed to the decoder 126.

The TGN 104 can be trained with one or more different decoders 126. The TGN 104 includes an aggregator 128, a message function 116, a memory updates 118, a memory 120, and an encoder 130. The memory 120 stores the states of all the nodes 108, 112 of the graph 102. The one or more entries in the memory 120 corresponding to a given node 108, 112 act as a representation of the past interactions of the given node 108, 112. For each node 108, 112 there is a separate state vector sᵢ(t) for each node i at time t. When a new node 108, 112 appears, a corresponding state initialized as a vector of zeros can be added to the memory 120. Moreover, since the memory 120 for each node 108, 112 is a MSV (and not a learned parameter), the MSV can be updated at test time when the model ingests a new interaction.

The message function 116 is a mechanism of updating the memory 120. Given an interaction between nodes 108 and 112 at time t, the message function 116 computes two messages (one for node 108 and one for node 112). The messages are state vectors used to update the memory 120. The message is a function of the memory 120 of nodes 108 and 112 at an instance of time, t, immediately preceding the interaction between the nodes 108 and 112, the interaction time t, and edge features (if there are any). An aggregator 128 can batch messages and provide the batched messages to the message function 116.

The memory updater 118 is used to update the memory 120 with the messages (e.g., batched messages) from the message function 116. The memory updater 118 can be implemented using a recurrent NN (RNN). Given that the one or more entries in the memory 120 corresponding to a node 108, 112 is a vector updated over time, the vector can become stale or be out of date. To avoid this the memory updater 118 computes the temporal embedding of a node 108, 112 by performing a graph aggregation over the spatio-temporal neighbors of that node 108, 112. Even if the node 108, 112 has been inactive for a while, it is likely that some of its neighboring nodes have been active. By aggregating the entries in the memory 120 of the node 108, 112 and its spatiotemporal node neighbors, TGN can compute an up-to-date embedding for the node 108, 112. A graph attention technique can be used to determine which neighbors are most important to a given node 108, 112 based on the memory 120.

The edge 110 of the graph 102 is represented using full edge features passed to the TGN 104. Embeddings for the full edge features are encoded by the TGN 104 and stored as features of the edge 110. The decoder 106 operates on the embeddings to predict a future event.

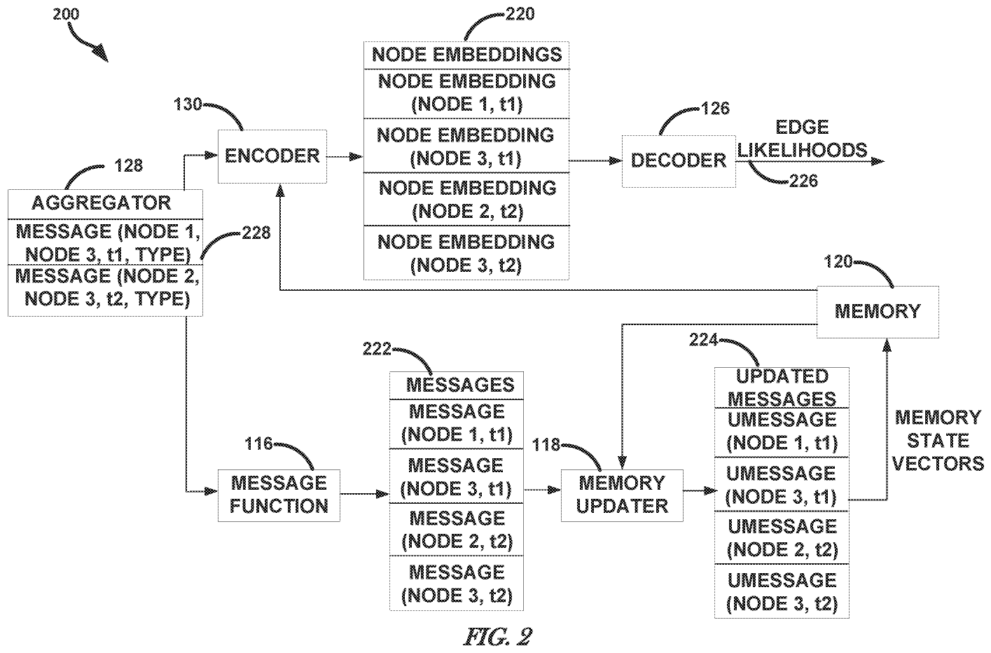

FIG. 2 illustrates an exploded view diagram of an embodiment of a portion 200 of the system 100. The portion 200 included in FIG. 2 includes parts of the TGN 104 and the decoder 126. The aggregator 128 receives and aggregates messages 228. The messages 228 specify a source node of an event, a destination node of an event, a type of the event, and a time of the event. The source node and destination node can be specified by a respective unique identification. The type is a value that indicates an action associated with the event. In the context of social networks, the type can indicate a like, a follow, a re-post, or the like. The time indicates a time about which the event occurred.

The message function 116 receives the aggregated messages 228 and generates individual node messages 222 based on the aggregated messages 228. The individual node messages 222 include the relevant information from a corresponding message of the aggregated messages 228 as it relates to an individual node. For each message of the aggregated messages 228, the message function 116 can generate two individual node messages 222, one for the source node and one for the destination node indicated in the message of the aggregated messages 228. The memory updater 118 can generate updated messages 224 (sometimes called memory state vectors) based on the messages 222 and one or more entries (sometimes called state vectors) in the memory 120. The memory updater 118 operates on the messages 222 and relevant state vectors to generate the updated messages 224. The updated messages 224 are respective new state vectors for the individual node of the message 222.

The encoder 130 generates node embeddings 220 based on the state vectors of the nodes from the memory 120 and the aggregated messages 228. The encoder 130 provides the input that the decoder 126 used to generate edge likelihoods 226. The edge likelihoods 226 indicate how likely it is that an edge of a given type will occur between two nodes. To train the aggregator 128, message function 116, and memory updater 118, one can update the memory 120 with messages coming from previous batches, predict the edge likelihoods 226, and then update with messages coming from current batches. This can be accomplished by using a “raw message store” that stores batches of messages until they are used for updating the memory 120.

An example of a TGN system with multiple interacting graphs in which nodes of a first graph can interact with other nodes of the first graph, nodes of the first graph can interact with nodes of a second graph, nodes of the second graph can interact with other nodes of the second graph, nodes of the second graph can interact with nodes of the first graph, or a combination thereof. To achieve such a system, modifications to traditional TGN, described regarding FIGS. 1 and 2, are made and described. The embodiments are described regarding maritime tracking but are applicable wherever messages are generated and indicated interactions between entities over time. Entities in this context can be objects, institutions, people, businesses, roads, vehicles, buildings, waterways, locations, or other that can interact or be interacted with over time.

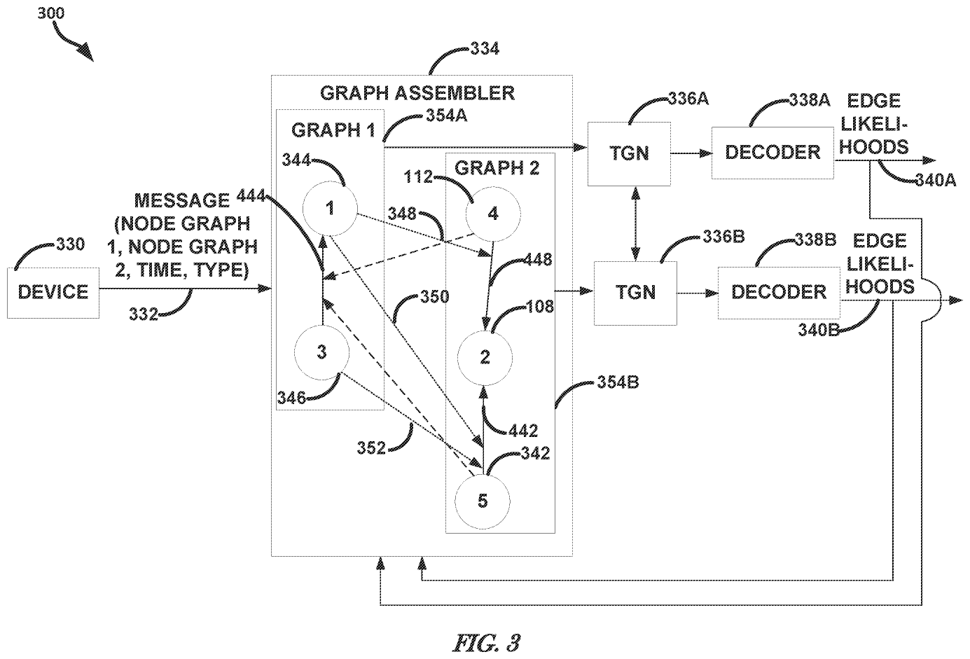

FIG. 3 illustrates, by way of example, a diagram of an embodiment of a multiple graph TGN system 300. The TGN system 300 includes one or more devices 330 that produce messages 332. The messages 332 indicate two or more entities associated with an event of a specified type, and a corresponding time of the event. The messages 332 are similar to the messages of the aggregated messages 228, with the messages 332 accounting for potential interaction between more than two entities (nodes).

Nodes 344, 346 of the graph 354A include an edge 444 therebetween. Nodes 112 and 108 of the graph 354B include an edge 448 therebetween and nodes 108 and 342 of the graph 354B include an edge 442 therebetween.

A graph assembler 334 can assemble graphs 354A and 354B. The graph assembler 334 provides a visual representation of nodes 344, 346 112, 108, 342 and node to edge mappings 348, 350, 352 and retains a data representation of the graphs 354A, 354B and node to edge mappings 348, 350, 352 between the graphs 354A, 354B.

Modified TGNs 336A, 336B operate on the data representing the nodes and edges maintained by the graph assembler 334 and generate an embedding representation of the nodes in the graphs 354A, 354B and node to edge mappings 348, 350, 352 there between. The graph assembler 334 creates node to edge mappings at each timestep between nodes in graph 354A and 354B when the features for a node in graph 354A reference a node ID in graph 354B or vice versa. The decoders 338A, 338B operate on the embedding from the respective TGNs 336A, 336B and produce a prediction, such as a likelihood of an edge existing between nodes of one or more of the graphs 354A, 354B (represented as edge likelihoods 340A, 340B in FIG. 3).

To manage node to edge mappings 348, 350, 352, the mappings 348, 350, 352 can be provided with a globally unique ID among all of the node IDs and edge IDs of all the graphs 354A, 354B. The mappings 348, 350, 352 can change over time and in fact may not exist at each time step. To accommodate this, each of the mappings 348, 350, 352 can be represented by state vectors associated with the nodes to be mapped as edge features in the other graph. For example, mapping 348 includes the state vector for the node 112 stored and associated with the ID that uniquely represents the mapping 348. These mappings 348, 350, 352 are illustrated as being between nodes and edges of different graphs 354A, 354B as this is the core mechanism for sharing graph state.

The graphs 354A, 354B can be trained concurrently. Concurrent training of the graphs 354A, 354B can include batch synchronization between graphs 354A, 354B. Batch synchronization includes training a first graph 354A up to a specified time, then training a second graph 354B up to a specified time, then training the first graph 354A past the specified time to a second specified time, then training the second graph 354B up to the second specified time, and so on. In this way, the graphs 354A, 354B can be time synchronized.

Using the MSV (from the memory 120) to create edge features based on the node to edge mappings 348, 350, 352 allows the mappings 348, 350, 352 to have edge features generated as each graph 354A, 354B is trained at each timestep. This avoids a problem of deadlock that is realized if one tries to use embeddings from the encoder 130 as features from the mappings 348, 350, 352, Instead, the mappings 348, 350, 352 can have MSVs (from the memory 120) and do not rely on embeddings for their representation.

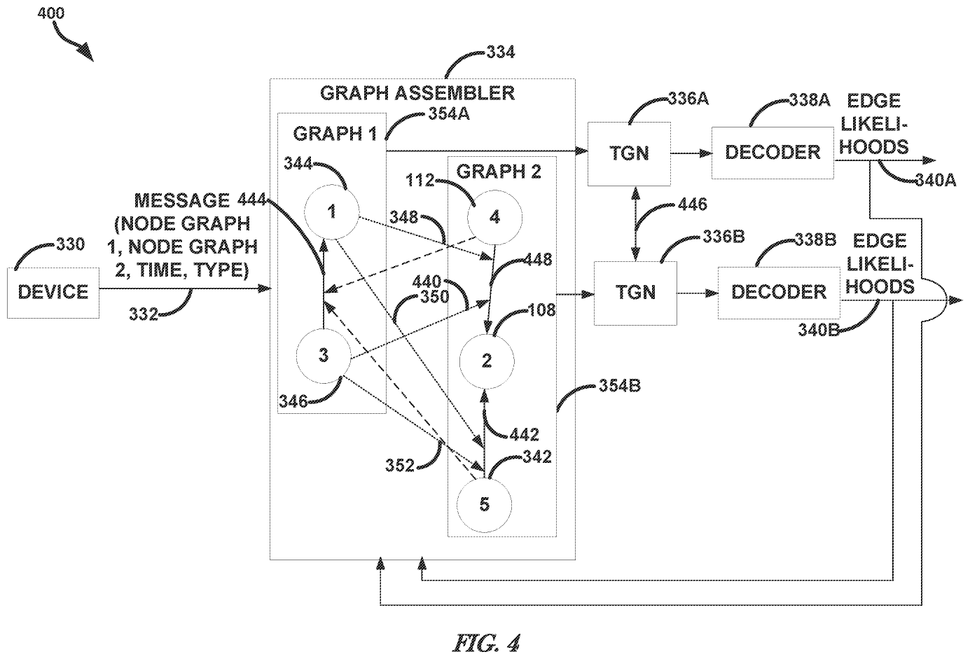

FIG. 4 illustrates, by way of example, a block diagram of an embodiment of a system 400 that includes the system 300 after another message 332 is received and processed. The system 400 includes an additional node-to-edge mapping 440 between the node 346 and the edge 448. The message 332, in the example of FIG. 4, indicated that an interaction between node 112 and 108 represented by edge 448 in Graph 2 (354B?) involved node 346 from Graph 1 (354A). For example, nodes 112 and 108 may represent ships involved in a fishing activity and node 346 is the location at which those ships were observed performing this activity.

The graph assembler 334 added the node-to-edge mapping 440 based on the message 332. The TGNs 336A, 336B generated embeddings of the graphs 354A, 354B based on the message 332 and prior received messages. The decoder 338B predicted that the nodes 108 and 342 are related based on the node 346 being associated with both nodes 108 and 342.

The TGNs 336A, 336B share data (indicated by arrow 446) by encoding the node-to-edge mapping 348, 350, 352, 440 between graphs. The MSV of the node as features in the corresponding edges 442, 444, 448 of the graph indicate relations in one graph 354B to another graph 354A and vice versa. The TGN 336A, for example, can use the MSV of node 112 as features on any incoming or outgoing edges of node 344 in graph 354A and the TGN 336B can use the MSV of node 344 as features for any incoming or outgoing edges of node 112 in graph 354B

In this way, entities from the graph 354A can inform patterns of entity association in the graph 35413 and vice versa. The graph embeddings from the TGNs 336A, 336B can be used to make predications or compute high dimensional pattern of life state. In the context of ship tracking, the nodes 344, 346 of the graph 354A can represent maritime vessels and the nodes 112, 108, 342 of the graph 354B can represent locations. The node to edge mappings 348, 350, 440, 352 between the graphs 354A, 354B represents that the vessel represented by the node 344, 346 was at the location represented by the node 112, 342, 108. This association can be provided by the message 332, which can detail an observation of the vessel at the location. The TGN 336A and decoder 338A can predict vessel interactions and the TGN 336B and decoder 338B can represent location interactions.

In summary, an approach of embodiments can include identifying nodes in the graph 354A, 354B that are referenced as features by nodes in the other graph 354B, 354A. Embodiments can add the MSV of the node in the first graph 354A to outgoing and incoming edges of the corresponding node in the second graph 354B.

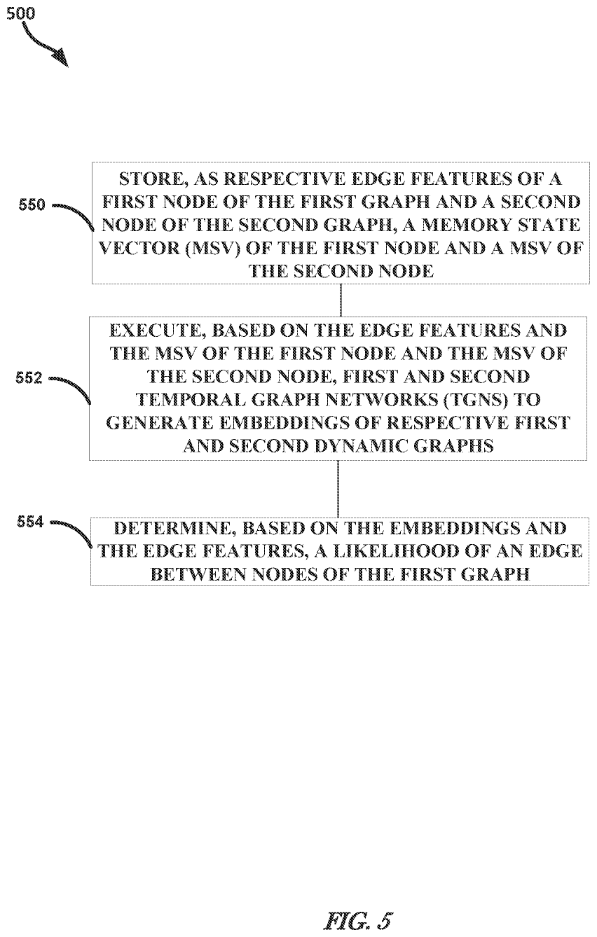

FIG. 5 illustrates, by way of example, a diagram of an embodiment of a method 500 for multiple interacting dynamic graph operation. The method 500 as illustrated includes storing, as respective edge features of a first node of the first graph and a second node of the second graph, a memory state vector (MSV) of the first node and a MSV of the second node, at operation 550; executing, based on the edge features and the MSV of the first node and the MSB of the second node, first and second temporal graph networks (TGNs) to generate embeddings of respective first and second dynamic graphs, at operation 552; and determining, based on the embeddings, a likelihood of an edge between nodes of the first graph, at operation 554. The method 500 can further include associating respective globally unique identifications (IDs) with each of nodes of the first graph, edges of the first graph, nodes of the second graph, edges of the second graph, and node-to-edge mappings between the first graph and the second graph.

The method 500 can further include co-temporally training the TGNs. The method 500, wherein co-temporally training the TGNs includes training the first TGN with data corresponding to events that occurred up to a first specified time, then training the second TGN with the data corresponding to the events that occurred up to the first specified time, then training the first TGN with data corresponding to events that occurred up to a second specified time after the first specified time, and then training the second TGN with data corresponding to events that occurred up to the second specified time.

The method 500 can further include receiving additional observation indicating a first entity corresponding to a third node of the first graph interacted with a second entity corresponding to a fourth node of the second graph. The method 500 can further include generating a node-to-edge mapping between the third node and an edge of the fourth node. The method 500 can further include storing, as features of the edge of the fourth node, memory state vectors of the third node and the fourth node.

The method 500 can further include, wherein the memory state vectors of the third and fourth node are stored as features of all incoming and outgoing edges of the third and fourth nodes. The method 500 can further include, wherein nodes of the first graph represent respective maritime vessels and nodes of the second graph represent respective locations.

Artificial intelligence (Al) is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as text prediction.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process, such as to train the TGNs 336A, 336B, decoder 338A, 338B or a portion thereof may be used to determine appropriate weights by selecting initial weights.

In some examples, initial weights may be randomly selected. Training data is fed into the NN and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

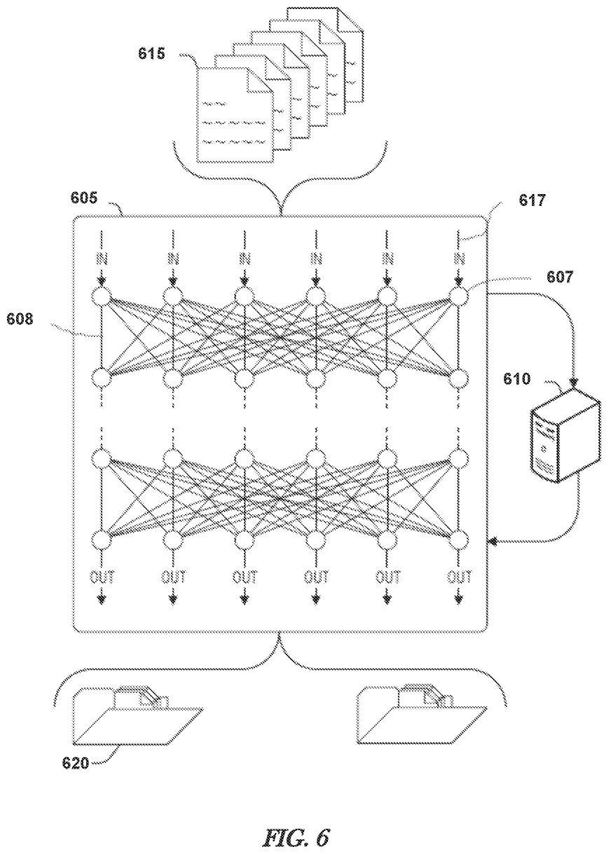

FIG. 6 is a block diagram of an example of an environment including a system for neural network training. The resulting NN can predict entity interactions using interacting dynamic graphs. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 607 within layers. Thus, a set of processing nodes 610 is arranged to perform the training of the ANN 605.

The set of processing nodes 610 is arranged to receive a training set 615 for the ANN 605. The ANN 605 comprises a set of nodes 607 arranged in layers (illustrated as rows of nodes 607) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as a word, symbol, other part of speech, or the like. Each value of the training or input 617 to be classified after ANN 605 is trained, is provided to a corresponding node 607 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 617 will be assigned into categories), for example. The training performed by the set of processing nodes 607 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 607 (e.g., neurons) are trained independently. In an example, the nodes are trained on different hardware.

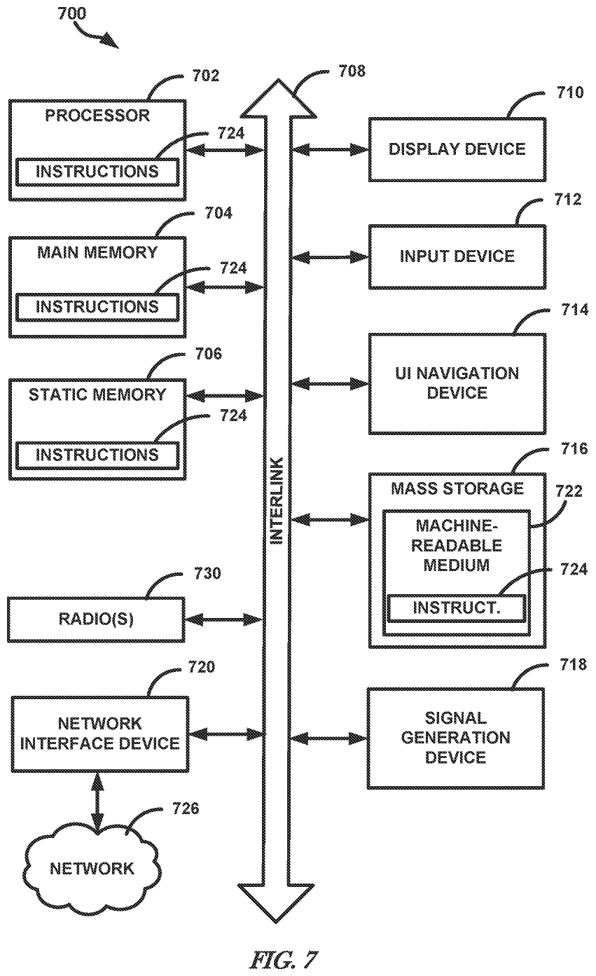

FIG. 7 illustrates, by way of example, a block diagram of an embodiment of a machine in the example form of a computer system 700 within which instructions, for causing the machine to perform any one or more of the methodologies discussed herein, may be executed. One or more of the TGN 104, decoder 126, device 330, graph assembler 334, TGN 336A, 336B, decoder 338A, 338B, method 500, or a component or operation thereof can be implemented using one or more components of the computer system 600. One or more of the TGN 104, decoder 126, device 330, graph assembler 334, TGN 336A, 336B, decoder 338A, 338B, method 500, or a component thereof can include one or more components of the computer system 700. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)), The computer system 700 also includes an alphanumeric input device 712 (e.g., a keyboard), a user interface (UI) navigation device 714 (e.g., a mouse), a mass storage unit 716, a signal generation device 718 (e.g., a speaker), a network interface device 720, and a radio 730 such as Bluetooth, WWAN, WLAN, and NFC, permitting the application of security controls on such protocols.

The mass storage unit 716 includes a machine-readable medium 722. on which is stored one or more sets of instructions and data structures (e,g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Notes and Examples

Example 1 includes a device comprising processing circuitry and a memory including instructions that, when executed by the processing circuitry, cause the processing circuitry to perform operations comprising executing first and second temporal graph networks (TGNs) to generate embeddings of respective first and second dynamic graphs, storing, as respective edge features of a first node of the first graph and a second node of the second graph, a memory state vector of the first node and a memory state vector of the second node, and determining, based on the embeddings and the edge features, a likelihood of an edge between nodes of the first graph.

In Example 2, Example 1 can further include, wherein the operations further comprise associating respective globally unique identifications (IDs) with each of nodes of the first graph, edges of the first graph, nodes of the second graph, edges of the second graph, and node-to-edge mappings between the first graph and the second graph.

In Example 3, at least one of Examples 1-2 can further include, wherein the operations further comprise co-temporally training the TGNs.

In Example 4, Example 3 can further include, wherein co-temporally training the TGNs includes training the first TGN with data corresponding to events that occurred up to a first specified time, then training the second TGN with the data corresponding to the events that occurred up to the first specified time, then training the first TGN with data corresponding to events that occurred up to a second specified time after the first specified time, and then training the second TGN with data corresponding to events that occurred up to the second specified time.

In Example 5, at least one of Examples 1-4 can further include, wherein the operations further comprise receiving additional observation indicating a first entity corresponding to a third node of the first graph interacted with a second entity corresponding to a fourth node of the second graph, generating a node-to-edge mapping between the third node and an edge of the fourth node, and storing, as features of the edge of the fourth node, memory state vectors of the third node and the fourth node.

In Example 6, Example 5 can further include, wherein the memory state vectors of the third and fourth node are stored as features of all incoming and outgoing edges of the third and fourth nodes.

In Example 7, at least one of Examples 1-6 can further include, wherein nodes of the first graph represent respective maritime vessels and nodes of the second graph represent respective locations.

Example 8 includes a computer-implemented method that performs the operations of one of Examples 1-7.

Example 9 includes a non-transitory machine-readable medium including instructions that, when executed by a machine, cause the machine to perform operations comprising the operations of one of Examples 1-7.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A device comprising:
processing circuitry; and
a memory including instructions that, when executed by the processing circuitry, cause the processing circuitry to perform operations comprising:
storing, as respective edge features of a first node of the first graph and a second node of the second graph, a memory state vector (MSV) of the first node and a MSV of the second node;
executing, based on the edge features and the MSV of the first node and the MSV of the second node, first and second temporal graph networks (TGNs) to generate embeddings of respective first and second dynamic graphs;
and
determining, based on the embeddings, a likelihood of an edge between nodes of the first graph.

2. The device of claim 1, wherein the operations further comprise associating respective globally unique identifications (IDs) with each of nodes of the first graph, edges of the first graph, nodes of the second graph, edges of the second graph, and node-to-edge mappings between the first graph and the second graph.

3. The device of claim 1, wherein the operations further comprise co-temporally training the TGNs.

4. The device of claim 3, wherein co-temporally training the TGNs includes training the first TGN with data corresponding to events that occurred up to a first specified time, then training the second TGN with the data corresponding to the events that occurred up to the first specified time, then training the first TGN with data corresponding to events that occurred up to a second specified time after the first specified time, and then training the second TGN with data corresponding to events that occurred up to the second specified time.

5. The device of claim 1, wherein the operations further comprise:
receiving observation data indicating a first entity corresponding to a third node of the first graph interacted with a second entity corresponding to a fourth node of the second graph;
generating a node-to-edge mapping between the third node and an edge of the fourth node; and
storing, as features of the edge of the fourth node, memory state vectors of the third node and the fourth node.

6. The device of claim 5, wherein the memory state vectors of the third and fourth node are stored as features of all incoming and outgoing edges of the third and fourth nodes.

7. The device of claim 1, wherein nodes of the first graph represent respective maritime vessels and nodes of the second graph represent respective locations.

8. A computer-implemented method comprising:
executing first and second temporal graph networks (TGNs) to generate embeddings of respective first and second dynamic graphs;
storing, as respective edge features of a first node of the first graph and a second node of the second graph, a memory state vector of the first node and a memory state vector of the second node; and
determining, based on the embeddings and the edge features, a likelihood of an edge between nodes of the first graph.

9. The method of claim 8, further comprising associating respective globally unique identifications (IDs) with each of nodes of the first graph, edges of the first graph, nodes of the second graph, edges of the second graph, and node-to-edge mappings between the first graph and the second graph.

10. The method of claim 8, further comprising co-temporally training the TGNs.

11. The method of claim 10, wherein co-temporally training the TGNs includes training the first TGN with data corresponding to events that occurred up to a first specified time, then training the second TGN with the data corresponding to the events that occurred up to the first specified time, then training the first TGN with data corresponding to events that occurred up to a second specified time after the first specified time, and then training the second TGN with data corresponding to events that occurred up to the second specified time.

12. The method of claim 8, further comprising:
receiving observation data indicating a first entity corresponding to a third node of the first graph interacted with a second entity corresponding to a fourth node of the second graph;
generating a node-to-edge mapping between the third node and an edge of the fourth node: and
storing, as features of the edge of the fourth node, memory state vectors of the third node and the fourth node.

13. The method of claim 12, wherein the memory state vectors of the third and fourth node are stored as features of all incoming and outgoing edges of the third and fourth nodes.

14. The method of claim 8, wherein nodes of the first graph represent respective maritime vessels and nodes of the second graph represent respective locations.

15. A non-transitory machine-readable medium including instructions that, when executed by a machine, cause the machine to perform operations comprising:
executing first and second temporal graph networks (TGNs) to generate embeddings of respective first and second dynamic graphs;
storing, as respective edge features of a first node of the first graph and a second node of the second graph, a memory state vector of the first node and a memory state vector of the second node; and
determining, based on the embeddings and the edge features, a likelihood of an edge between nodes of the first graph.

16. The non-transitory machine-readable medium of claim 15, wherein the operations further comprise associating respective globally unique identifications (IDs) with each of nodes of the first graph, edges of the first graph, nodes of the second graph, edges of the second graph, and node-to-edge mappings between the first graph and the second graph.

17. The non-transitory machine-readable medium of claim 15, wherein the operations further comprise co-temporally training the TGNs.

18. The non-transitory machine-readable medium of claim 17, wherein co-temporally training the TGNs includes training the first TGN with data corresponding to events that occurred up to a first specified time, then training the second TGN with the data corresponding to the events that occurred up to the first specified time, then training the first TGN with data corresponding to events that occurred up to a second specified time after the first specified time, and then training the second TGN with data corresponding to events that occurred up to the second specified time.

19. The non-transitory machine-readable medium of claim 5, wherein the operations further comprise:
receiving observation data indicating a first entity corresponding to a third node of the first graph interacted with a second entity corresponding to a fourth node of the second graph;
generating a node-to-edge mapping between the third node and an edge of the fourth node: and
storing, as features of the edge of the fourth node, memory state vectors of the third node and the fourth node.

20. The non-transitory machine-readable medium of claim 19, wherein the memory state vectors of the third and fourth node are stored as features of all incoming and outgoing edges of the third and fourth nodes.

21. The non-transitory machine-readable medium of claim 15, wherein nodes of the first graph represent respective maritime vessels and nodes of the second graph represent respective locations.
